(19) United States
(12) Patent Application Publication
(10) Pub. No.: US 2019/0203022 A1
(43) Pub. Date: Jul. 4, 2019

(54) Thermoplastic Elastomers And Thermoplastic Vulcanizates

(71) Applicant: William J. FARRAH, Grosse Pointe Farms, MI (US)

(72) Inventor: William J. FARRAH, Grosse Pointe Farms, MI (US)

(21) Appl. No.: 16/240,345

(22) Filed: Jan. 4, 2019

Related U.S. Application Data
(60) Provisional application No. 62/613,556, filed on Jan. 4, 2018.

(51) Int. Cl. C08L 19/00; C08L 23/12; C08L 23/16; C08L 23/08; C08K 5/00

(52) U.S. Cl. CPC C08L 19/003; C08L 23/12; C08L 2207/04; C08L 23/0853; C08K 5/0091; C08L 23/16

(57) ABSTRACT

Thermoplastic vulcanizates and elastomers, and processes for preparation thereof from recycled vulcanized rubber, such as reclaimed tires.

### CROSS-REFERENCE TO RELATED APPLICATION

This application claims the benefit of U.S. Provisional Application No. 62/613,556, filed on Jan. 4, 2018. The entire disclosure of the above application is incorporated herein by reference.

### FIELD

The present disclosure relates to thermoplastic elastomers and thermoplastic vulcanizates, and processes for making thermoplastic elastomers and thermoplastic vulcanizates.

### BACKGROUND

This section provides background information related to the present disclosure, which is not necessarily prior art.

Thermoplastic elastomers (TPE) and thermoplastic vulcanizates (TPV) are used for a broad range of specific engineered applications, such as automotive components, building and construction products, household appliance parts, electrical components, and footwear, for example. While existing TPE's and TPV's and processes for their preparation are suitable, they are subject to improvement. For example, processes for manufacturing TPE's and TPV's that are less costly, faster, simpler, and more friendly to the environment as compared to current methods would be desirable. The present teachings include processes for preparing TPE's and TPV's that provide such advantages, as well as numerous others as one skilled in the art will appreciate.

### DETAILED DESCRIPTION

Example embodiments will now be described more fully with reference to the accompanying drawings.

The present teachings are directed to thermoplastic elastomers (TPE) and thermoplastic vulcanizates (TPV), and processes for preparation thereof from recycled (reclaimed) vulcanized rubber, such as from tires, including truck or car tires for example. Any steel is removed from the tires, which are ground into mesh of any suitable size, such as 50-110 mesh (particles per inch). The tires, particularly truck and car tires, advantageously provide natural rubber, which is already vulcanized.

Exemplary processes for preparation of a TPE and TPV include preheating a mixer to any suitable temperature, such as 160° F.-190° F. Any suitable mixer can be used, such as any suitable industrial mixer capable of mixing about 2,000 lbs. of recycled vulcanized rubber. The recycled vulcanized rubber can be 50-110 mesh (particles per inch), for example. Any suitable amount of vulcanized rubber can be included, such as between 10-50 units of vulcanized rubber. The vulcanized rubber is added to the mixer. By using recycled rubber that has already been vulcanized, the present teachings advantageously eliminate the need to vulcanize rubber, which can be costly, time consuming, and complex.

The present disclosure generally provides for the combination of thermoplastics with thermosets to make a product that processes like a thermoplastic, but has properties like or similar to thermosets. The following is an example of a general formula for a TPE in accordance with the present disclosure:
Polyolefin Polymer: 10-50 units;
Enhanced Polyolefin: 10-50 units;
Polyolefin Elastomer: 10-50 units;
Recycled Vulcanized Rubber: 10-50 units;
Protective System: 1-5;
Processing Aids: 1-5.
   The following is an example of a general formula for a TPV in accordance with the present disclosure:
Polyolefin Polymer: 10-50 units;
Enhanced Polyolefin: 10-50 units;
Polyolefin Elastomer: 10-50 units;
Recycled Vulcanized Rubber: 10-50 units;
Protective System: 1-5;
Processing Aids: 1-5;
Cure System: 1-5.
   The following is an example of an additional general formula for a TPV in accordance with the present disclosure:
42% Recycled Vulcanized Rubber
35% EPDM
22% Polypropylene
2% EVA
1% Antioxidant 1010
1% Antioxidant ZMTI
   The following is an example of another general formula for a TPV in accordance with the present disclosure:
42% Recycled Vulcanized Rubber
35% Polypropylene
22% EPDM
2% EVA
1% Antioxidant 1010

Any suitable specific components of the above components may be used. For example and with respect to polymers, homopolymers and block copolymers, and polyolefin materials, the present disclosure provides for use of one or more of the following: linear low density polyethylene (LLDPE), such as Marlex 7120B offered by Chevron Phillips; low density polyethylene (LDPE), such as Marlex 4538A offered by Chevron Phillips; high density polyethylene (HDPE), such as Marlex 9012 offered by Chevron Phillips; polypropylene (PP), such as Pinnacle Polymer 1120H offered by Unipol; polyolefin rubber elastomer (EPDM), such as Vistalon 7001 offered by Exxon Mobile.

For example and with respect to enhanced polyolefins, the present disclosure provides for use of one or more of the following: EG 8200m G offered by Dow-Affinity; 8150 offered by Dow-Engage; 5400G offered by Dow/Elite; 5400G offered by Dow/Elite; INFUSE™ Olefin Block Copolymers offered by Dow, such as INFUSE™ 9107; 6102 FL offered by Exxon Mobil-Vistamaxx.

For example and with respect to the protective system, the present disclosure provides for use of one or more of the following: antioxidant—hindered phenol, such as Irganox 1010 offered by Ciba; antioxidant—phenyl & naphthyl amine, such as Agerite Superflex Solid G offered by R.T. Vanderbilt; a miscellaneous antioxidant, such as Vanox ZMTI offered by R.T. Vanderbilt; antioxidant—quinolone, such as Flector TMQ offered by Flexsys.

For example and with respect to the processing aid, the present disclosure provides for use of copolymer EVM, such as Lavapren 500 offered by Lanxess.

For example and with respect to the cure system, the present disclosure provides for use of one or more of the following: resin-alkyl phenol-formaldehyde, such as Sp 1045 offered by Si Resin; peroxide-organic peroxide, such as Vulcup offered by Arkema Peroxide.

Any of the compounds identified above and contemplated by the present disclosure may be recycled compounds or non-recycled compounds.

The resulting TPV's and TPE's can be provided in any suitable form, such as extruded from the extruder as pellets or strips. The TPV's and TPE's can be used to manufacture any suitable product in any suitable manner. For example, the TPV's and TPE's formed according to the present teachings can be inserted in any suitable molding, such as any suitable injection molding, to mold any suitable product. Suitable products include automotive components, building and construction components, household appliance parts, electrical components, pavement sealants, and shoes, such as rubber shoes, soles, etc. More specifically, the TPV's and TPE's according to the present teachings can be advantageously used for manufacturing weather seals, vehicle air dams, under-hood vehicle applications, under-car vehicle applications, vehicle air ducts, tubing, molded seals, grommets, suspension bellows, cable jacketing, plugs, bumpers, glazing seals, building seals, water stops, door seals, trunk seals, pump seals, pavement seals, wire connectors, and cable connectors. One skilled in the art will appreciate that various other products can be manufactured using the thermoplastic vulcanizates and elastomers according to the present teachings.

The TPV's and TPE's of the present disclosure advantageously meet or exceed various OEM specifications, such as, but not limited to, the following: General Motors 15812 (at least #5, 6, 7, 8) and 15813.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A thermoplastic elastomer comprising:
a polyolefin polymer;
an enhanced polyolefin;
a polyolefin elastomer;
recycled vulcanized rubber;
a protective system; and
a processing aide.

2. The thermoplastic elastomer of claim 1, wherein the recycled vulcanized rubber is 50-110 mesh (particles per inch) recycled vulcanized rubber.

3. The thermoplastic elastomer of claim 1, wherein the recycled vulcanized rubber is derived from tires.

4. The thermoplastic elastomer of claim 1, further comprising adding the recycled vulcanized rubber at 10-50 units per 100 units of rubber.

5. The thermoplastic elastomer of claim 1, further comprising forming a product from the thermoplastic, the product including at least one of the following: a weather seal; a vehicle air dam; an under-hood vehicle application;
an under-car vehicle application; a vehicle air duct; tubing; a molded seal; a grommet; a suspension bellow; cable jacketing; a plug; a bumper; a glazing seal; building seal; water stop; a pump seal; a pavement seal; a wire connector; a shoe; and a cable connector.

6. A thermoplastic vulcanizate comprising:
a polyolefin polymer;
an enhanced polyolefin;
a polyolefin elastomer;
recycled vulcanized rubber;
a protective system;
a processing aide; and
a cure system.

7. The thermoplastic vulcanizate of claim 6, wherein the recycled vulcanized rubber is 50-110 mesh (particles per inch) recycled vulcanized rubber.

8. The thermoplastic vulcanizate of claim 6, wherein the recycled vulcanized rubber is derived from tires.

9. The thermoplastic vulcanizate of claim 6, further comprising adding the recycled vulcanized rubber at 10-50 units per 100 units of rubber.

10. The thermoplastic vulcanizate of claim 6, further comprising forming a product from the thermoplastic, the product including at least one of the following: a weather seal; a vehicle air dam; an under-hood vehicle application; an under-car vehicle application; a vehicle air duct; tubing; a molded seal; a grommet; a suspension bellow; cable jacketing; a plug; a bumper; a glazing seal; building seal; water stop; a pump seal; a pavement seal; a wire connector; a shoe; and a cable connector.

11. A thermoplastic vulcanizate comprising:
recycled vulcanized rubber;
Polypropylene;
EPDM;
EVA; and
Antioxidant 1010.

12. The thermoplastic vulcanization of claim 11, further comprising Antioxidant ZMTI.

13. The thermoplastic vulcanizate of claim 11, wherein the recycled vulcanized rubber is 50-110 mesh (particles per inch) recycled vulcanized rubber.

14. The thermoplastic vulcanizate of claim 11, wherein the recycled vulcanized rubber is derived from tires.

15. The thermoplastic vulcanizate of claim 11, further comprising adding the recycled vulcanized rubber at 10-50 units per 100 units of rubber.

16. The thermoplastic vulcanizate of claim 11, further comprising forming a product from the thermoplastic, the product including at least one of the following: a weather seal; a vehicle air dam; an under-hood vehicle application; an under-car vehicle application; a vehicle air duct; tubing; a molded seal; a grommet; a suspension bellow; cable jacketing; a plug; a bumper; a glazing seal; building seal; water stop; a pump seal; a pavement seal; a wire connector; a shoe; and a cable connector.
